(19) United States
(12) Patent Application Publication
(10) Pub. No.: US 2016/0234147 A1
(43) Pub. Date: Aug. 11, 2016

(54) Integrated Digital Filtering System

(71) Applicant: Michele S. Joel, Tuscon, AZ (US)

(72) Inventor: Michele S. Joel, Tuscon, AZ (US)

(21) Appl. No.: 14/792,610

(22) Filed: Jul. 7, 2015

Related U.S. Application Data
(60) Provisional application No. 62/022,095, filed on Jul. 8, 2014.

(51) Int. Cl. H04L 12/58; H04L 29/08

(52) U.S. Cl. CPC H04L 51/12; H04L 51/32; H04L 67/18; H04L 67/10

(57) ABSTRACT

A system and method for filtering improper content. A communication is received from transmission from a first device. The communication is reviewed to determine whether the communication includes the improper content. The communication is filtered in response to determining the communication includes the improper content.

### CROSS-REFERENCE TO RELATED APPLICATIONS

The present application is a nonprovisional application which claims the benefit of U.S. Provisional Patent Application No. 62/022,095 filed Jul. 8, 2014, entitled “Integrated Digital Filtering System,” and which are both incorporated herein by reference in their entirety as if fully set forth herein.

### TECHNICAL FIELD

The present disclosure relates to an integrated social media system that comprises a system, method, and device to screen content of a social media message before the message is distributed in public venues with the goal of protecting users or third parties from inappropriate message content. The system may also screen the origin of messages forwarded by the user to ensure no content is forwarded from parties with objectionable public presences with the goal of protecting the user from inadvertent affiliation with the objectionable origin. The user may use or implement the system at a stationary terminal, server, or network device using a specially programmed computer or with a mobile version making use of mobile devices in combination with a mobile application.

### BACKGROUND

Mobile devices (e.g., cellular phones, smartphones, PDAs, tablet computers, etc.) have become ubiquitous personal items that are carried by the vast majority of the population. These mobile devices are generally capable of a variety of tasks (in addition to making telephone calls), including browsing the Internet, downloading and using mobile applications (or “apps”), messaging (e.g., “text” messaging in the form of SMS and MMS messages), performing emailing and calendaring functions, and a variety of other functionalities.

Currently, there are numerous social media platforms such as LinkedIn, Facebook, Twitter, Pinterest, Google+, Tumblr, etc. Due to human error, the messages that are broadcast may have unintended meanings or content. Due to a typical person's frequent interaction with online social media communities, typographical errors and human error miscommunication occur frequently. In addition, current technology is also part of the problem, with autocorrect functions erroneously changing an intended word to the detriment of the message. Further, organizations, companies, and individuals may post on each of these online venues which may require multiple steps to communicate information. There is a need for an integrated social media system to permit users to create a message, filter it, and then send that message out once in a way that posts to one or all of their social media accounts.

Another issue is the prevalence of “cyber bullying,” which has resulted in a range of negative consequences as varied as hurt feelings to teen suicides. Young children and teenagers now are able to send social media messages, yet many do not possess the judgment necessary to keep their messages age-appropriate. Because the frontal cortex of children/teenagers' brains is not fully developed, they lack ability to fully consider future consequences in decision-making As a result, “sexting” has also become a problem, with children sending inappropriate photos and messages which in turn go viral and are shared with many recipients not intended by the original sender. These photos and messages may harm these children's self-esteem and reputation. The content may be impossible to remove from the public domain. Therefore, there is a strong need for parents to have a system whereby social media communications may be stopped from being delivered in real-time based on inappropriate images or inappropriate content. Parents also need a way to stop messages created on devices used by their children that may damage the reputation of innocent children. By monitoring social media blasts, parents will know if their child is guilty of bullying another child and have the ability, along with the parent of the bullied child, to intervene and stop damaging messages -before they snowball in severity by virtue of being posted in a public forum.

### SUMMARY

Aspects of the present disclosure relate to systems, apparatuses, and computer implemented methods for screening social media messages, both for content and, in the case of forwarded messages, for objectionable origin prior to being broadcast on various communication networks and systems, such as social media platforms. The described embodiments may be implemented from a server or other network device or from a mobile device utilizing a mobile application.

Due to a typical person's frequent interaction with online social media communities, typing errors and human error miscommunication commonly occur. Sometimes these errors are caused by technology intending to assist, such an “autocorrect” function. For example, consumers may post a message on a social media network only to realize moments later that there was an error caused by an autocorrect spell function that changes the meaning of the message. Although there are usually avenues to later retract these erroneous messages, there is still the possibility of “friends” or the general public to see the erroneous post prior to the retraction. Therefore, the illustrative embodiments provide a layer of protection between the generation of a post and its public appearance.

In one embodiment, the system may also be used to screen message content, images, and communications viewable not only by friends, but also by “friends of friends” or friend's followers based on non-user based social media privacy permissions and seen by other children to protect children from cyber-bullying, sexting, and the transmission of inappropriate social media messages.

The illustrative embodiments improve methods by which a system screens outside content or messages, such as text messages or emails, from reaching the user. The illustrative embodiments relate to screening of the user's own messages in a dynamic social media setting where persons are affiliated both knowingly and unknowingly through a weblike network of “friends” or “followers.” This is especially helpful with teenagers because they do not have the foresight to know the effect of their bullying comments on another child (especially those driven to suicide), nor do some children realize that certain photos of themselves may be shared with millions of other people. Used by political campaigns, the illustrative embodiments may also protect against unintended affiliations.

Another problem has been the hacking of social media accounts. Most individuals know of at least one other person whose account has been “hacked” and inappropriate content or links posted, to the possible detriment of the user's reputation. The illustrative embodiments provide a system to automatically block these messages to serve as another layer of protection against this activity.

Further, there are organizational embodiments. Companies or marketers generate content (e.g., advertising content, promotional offers, discounts, interactive promotional content, status information, slogans or updates etc.) to be distributed to social media platforms. For example, corporations or groups have the need at times to ensure their employees communicate with the public in a consistent, unified manner. Several employees may have access to post social media posts, blog updates, and the like. The illustrative embodiments improve upon simply having a supervisor review content because the system aims to improve human error or lack of information which may cause errors made by employee or supervisor alike. The illustrative embodiments also protect against malicious posts by disgruntled employees. Supervisors also may not be present to review a post at the time a post needs to be broadcast on a social media platform, or may not yet have been cautioned as to certain topics by more senior executives.

The sender of the message may use the integrated social media system, which screens content such as keywords, phrases, images, links, audio, video, and user-generated criteria. The system may either accept or reject/block the transmission of message(s) to be sent to social media platforms, (e.g., Facebook, Twitter, LinkedIn, etc.), mobile SMS text services, emails or other means of electronic or wireless communication. Further, the message posting mechanism may integrate all social media accounts or communication platforms designated by the user so the user need only post the message once, publishing on all platforms. In this way, users are able to stop the transmission of a message prior to committing to the broadcast. Another embodiment, permits the override or editing of a previously rejected message and resubmission for screening.

The system screens not only user-created messages, but also messages containing all or portions of third party messages or content being “forwarded.” This feature not only screens the content of forwarded messages, but also the nature of the originating party through a screen of the third party's public web presence or social media presence for markers of the three main venues for controversy: sex, politics, and religion. As with user-created messages, the user may customize this origin feature to block forwarded messages originating from specific companies or individuals. For example, an NFL player might not want to forward any content by an individual or organization that conflicts with his corporate sponsorships. A company might not want to forward information originating from competing brands and so forth.

These and other aspects, features, and benefits of the claimed subject matter will become apparent from the following Detailed Description of the embodiments and aspects taken in conjunction with the following drawings, although variations and modifications thereto may be effected without departing from the spirit and scope of the novel concepts of the disclosure. Some of the various embodiments and variations have been discussed in the above summary, but others are discussed in the Detailed Description, as well. This Summary is not intended to limit those embodiments and variations claimed.

### BRIEF DESCRIPTION OF THE DRAWINGS

The present embodiments may be better understood, and numerous objects, features, and advantages made apparent to those skilled in the art by referencing the accompanying drawings.

FIG. 1 illustrates a screening process used in connection with an illustrative embodiment.

FIG. 2A is an illustrative user display showing a login process where the user authenticates the service through identifiers in accordance with an illustrative embodiment.

FIG. 2B is an illustrative user display whereby the user agrees to permit the application to operate in accordance with an illustrative embodiment.

FIG. 2C is an illustrative user display whereby various third party components are authenticated as being associated with the user in accordance with an illustrative embodiment.

FIG. 3 is an illustrative user display of the user's message history in accordance with an illustrative embodiment.

FIG. 4 is an illustrative user display whereby users may delete their message in accordance with an illustrative embodiment.

FIG. 5 is an illustrative user display whereby the user may start a new message in accordance with an illustrative embodiment.

FIG. 6 is an illustrative user display of an approval reply in accordance with an illustrative embodiment.

FIG. 7 is an illustrative user display of a rejected message in accordance with an illustrative embodiment.

FIG. 8A is an illustrative user display for the user giving choices of editing, overriding, or canceling selections in accordance with an illustrative embodiment.

FIG. 8B is an illustrative display of an override function in accordance with an illustrative embodiment.

FIG. 9 is an illustrative user display of the message history of the user's third party “followers or friends” messages in accordance with an illustrative embodiment.

FIG. 10, is an illustrative user display for selecting a third party “followers or friends” message in their history feed, whereby the user may edit the third party message and push the message through the filtering system which will post on the user's social media platform in accordance with an illustrative embodiment.

FIG. 11 is an illustrative display of an administrative console including a super administration and client administration, where the final approval and reject notification is screened in accordance with an illustrative embodiment.

FIG. 12 is an illustrative computing environment for implementing the embodiments and variations herein.

FIG. 13-20 are illustrative user displays I user interfaces in accordance with illustrative embodiments.

FIG. 21 shows a feature whereby the override function may be enabled or disabled for primary users by a secondary user in accordance with an illustrative embodiment.

FIG. 22 shows an example display showing all primary users over which an administrative user has permissions in accordance with an illustrative embodiment.

FIG. 23 shows as example user interface for the user level fork whereby users may customize text to be screened in accordance with an illustrative embodiment.

FIG. 24 shows an example display for a heat map in accordance with an illustrative embodiment.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. The methods and systems for filtering communications may be applicable to other methods, systems, and environments. In other instances, well-known instruction instances, protocols, structures and techniques have not been shown in detail in order not to obfuscate the description.

The illustrative embodiments provide a system, method, and devices for both tracking, screening, and filtering content. The content may be inappropriate or may pose a risk to the user personally, educationally, financially, or so forth. In one embodiment, the system may filter or screen social media posts, phone calls, fax messages, electronic conversations, web applications, plagiarism, misquotes, expert testimony, medical diagnosis, telecommunications channels, and conversations in physical spaces (e.g., hallways, classrooms, workplaces, etc.). The system may also provide a tracking tool to report when specific content is said, written, forwarded, cited, or so forth to overcome a potential issue. The system may also be custom configured for slang or regional dialects, call centers, dating compatibility, voice-to-text, bullying, and so forth.

Another problem the system solves is to notify users if content to be forwarded (for ex. “retweeted”) originated from entities or affiliations for which the user does not wish to associate. This is especially helpful in the political arena, as politicians more than ever now communicate in social media but do not want to inadvertently espouse or use even portions of content originating from radical groups or groups with different political values. The system herein is enabled to notify users within two degrees of separation as to content origins and notifies whether the origins of any content come from political, religious, or pornographic public sources, however, the system may be modified to provide further degrees of separation if need be.

The present art screens outside content, such as websites known to be inappropriate for children, or discrete text messages/emails, but the disclosed embodiments improve upon the art by screening dynamic content created by the user in social media. Accordingly, there is a long-felt but unresolved need for an intelligent system or method that is able to effectively filter social media messages prior to distributing content in those mediums. The primary user or a secondary supervisory third party (such as a corporate manager, parent, etc), who has permissions through this service, has the ability to stop the transmission of a communication prior to committing to the broadcast.

The claimed subject matter is now described with reference to the drawings. For purposes of explanation, numerous details are provided to provide a thorough understanding of the claimed subject matter. While various embodiments are shown herein, it may become evident to those skilled in the art that such embodiments are provided for the purpose of example only. Variations, changes, and substitutions may occur by those skilled in the art without departing from the embodiments; various alternatives therefore may be employed in practicing the embodiments.

Aspects of the present disclosure relate to a computer implemented system and method for filtering social media messages, both for content and, in the case of forwarded messages, for objectionable origin. The user may use the system at a stationary terminal using a specially programmed computer or with a mobile version making use of mobile devices in combination with a mobile app.

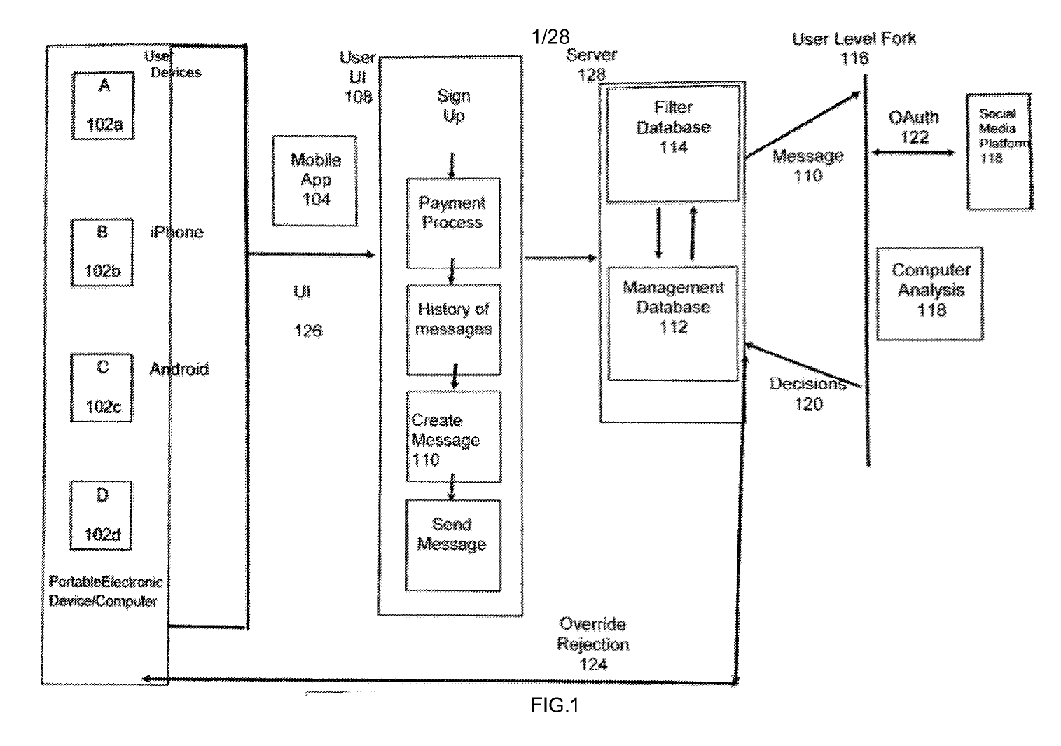

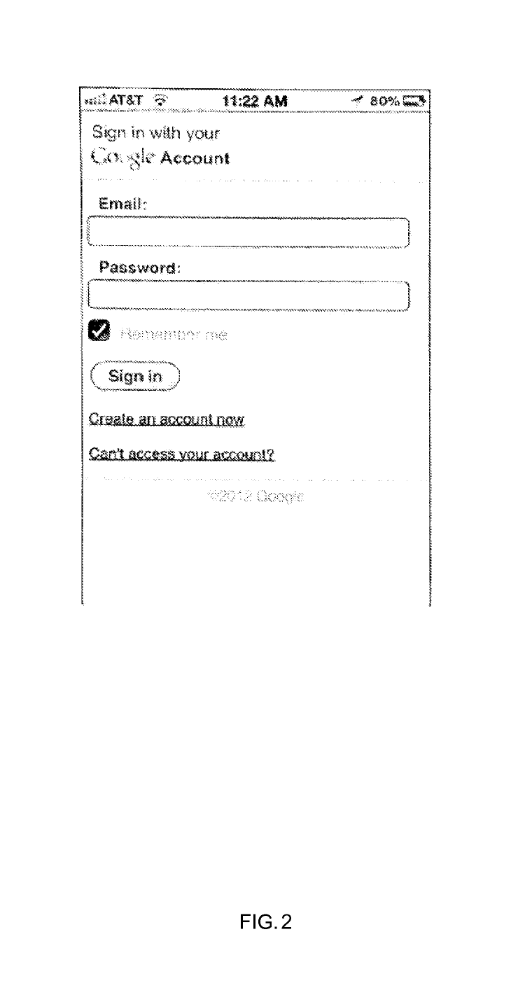

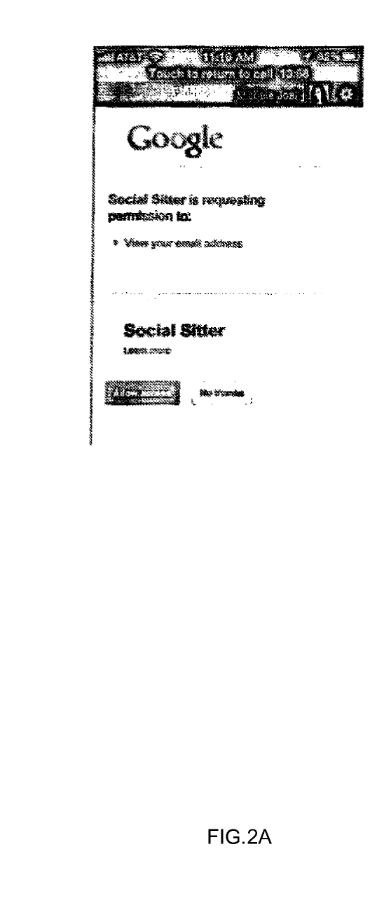

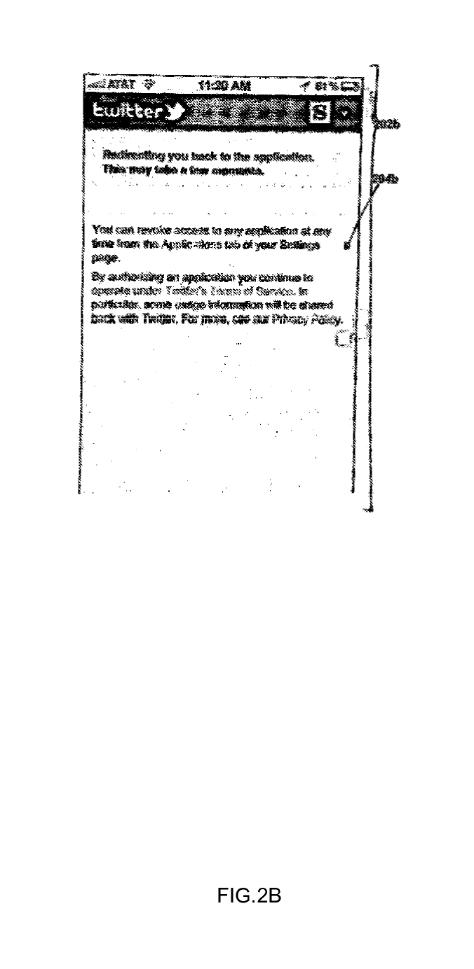

The system is comprised of a computing unit 1502 and a user device. The workflow blueprint is shown in FIG. 1. As generally indicated in FIGS. 1 and 2, the user would login 202 from a stationary computer or their mobile device 102a-d.

The terms “user device” and “mobile device” herein 100 include any suitable type of electronic device having a medium for storage and memory, such as handheld portable electronic devices including an iPhone, Android, iPad, computer, phone, smartphone, or other device capable of communicating with a computer network. In addition to the storage and memory components, the device may include necessary control circuitry, at least one processor, and I/O circuitry which may receive and convert user inputs and act as visibly perceptible display circuitry. The user device has tangible computer readable media and is specially programmed to execute program code or actions dictated by the computer readable media directed to implementing the methods herein. Computer readable media refers to tangible instructions, logic, data, code, or instructions for performing actions or running any algorithm that may be stored in memory of the user device, such as for example, a mobile app, but does not encompass transitory propagating signals. The mobile device may send and receive non-transitory computer readable media. In order to do so, servers may communicate with user devices across a network 128 and may transmit tangible computer files residing in memory.

The term “network” refers to the Internet, wireless communication network, or other communications systems, devices, and connections for connecting servers to user devices, and while the user devices are capable of receiving and sending computer readable media, this disclosure is limited to a computing unit coupled with a user device specially programmed to perform the screening mechanism disclosed herein. The structure of a computing unit for implementing the various embodiments above described is shown in FIG. 12. The computing unit executes and/or stores code programmed to implement the methods herein. This is comprised generally of I/O circuitry 1506, a processor 1508, a system that transfers data between components inside a computer or between computers 1512, user devices 1510, and memory for data storage 1504.

The initials “UI” in FIG. 1 refers to the “user interface.” The user display 126 or user interface (“UI” in FIG. 1) as referred to herein refers to the visually perceptible display on the user device resulting from a tangible computer file stored in its memory. The file or content may originate from across a network such as the Internet, a wireless communication network, or a system of connected networked computers. The display includes devices upon which information may be displayed in a manner perceptible to a user or otherwise communicated, such as a touchpad or touchscreen display, a computer monitor, speakers, projectors, and LED display, and similar components for producing visually perceptible output.

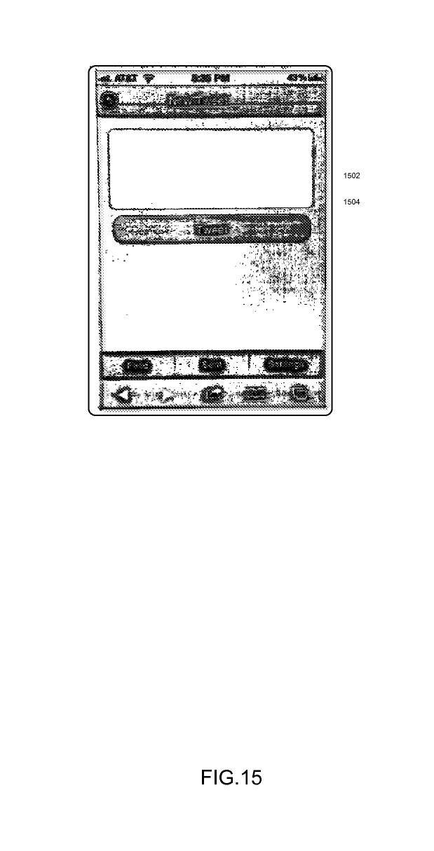

In one embodiment, the mobile app necessary to embed specialized program code in the computing environment, FIG. 15, may reside on a server or servers 128 and then downloaded onto a user device, or a plurality of user devices on (e.g., a corporate network, from the server(s)). The “server” as used herein may be one or more servers, cloud systems, network devices, and databases.

Mobile app as used herein refers to any mobile user device application, widget, tool, plug-in, gadget, or other dynamic content, object, or software which is recorded on a computer readable medium imparting social media filtering, screening, and management functionality so that users may use the system from anywhere using mobile devices. Computer readable medium used herein refers to the medium on which computer instructions are stored, but does not include intangible media, such as signals. The mobile embodiment may permit the social media screen by a primary user or a secondary user when those individuals are not near a stationary computer or like terminal.

A user may be an individual or organizational user. The user may be the primary user (for example the user who creates or forwards messages), or may be a secondary user with permissions to view activity of primary users. In some embodiments, a user may refer to multiple persons. Nothing herein implies that there may be only two users, primary and secondary, rather this discussion refers to an embodiment.

Turning now to FIG. 2, following the user's login, the system may proceed to authenticate the user's social media accounts through user provided indicia of ownership, such as providing email addresses 202 and password 204 or other such means known in the art for confirming the user's right to access social media accounts, ex. FIG. 2A. The system may also include a third party payment gateway 108 at this juncture, or at times set by the user and the system owner.

Following login, the user may create a message 110. Message refers to a communication and is sometimes referred to as a “post.” The message may contain content to be screened. Content may be written text, but may also be links the user wishes to post (e.g., website URL and the associated content), or any combination of text, links, images, video, audio, or other media. Content also includes images which may be analyzed for markers of inappropriate content, such as nudity, use of third party logos as subsequently discussed, or other customized markers to cause an alert, such as any time an image is of a user's child. Images sometimes themselves include text, that may be screened using hardware or software based OCR (optical character recognition) recorded on the computer readable medium housed in the computing unit or user device.

Either after or prior to the message being created, the system may under one embodiment seek user management credentials 112 and the user may designate what account the user is affiliated with, whether an organization or individual account. By way of explanation, the “management credential” pertains to the situation where there is a gathering of users with the same company or affiliation. The company or organization may have an account that would enable the company to monitor their employees that they are in compliance with their policies. In this disclosure, this interface and functionality is termed the “management credential.” The management credential is also where the user may customize those words that may be filtered as blacklisted terms, which may be rejected.

To further explain, the system may be used either in conjunction with an individual account or a company/organizational account used to monitor and filter social media communication by employees. The supervisory users may need to indicate which employees' to be monitored, rather than determine how to process those employees' media posts/messages into a rejected or accepted corporate communication.

Continuing with FIG. 1, the servers on the backend may hold the database 114 and authentication process 114. From there, the new message content is screened using algorithms to filter content and using user-customized parameters, such as targeted words 118, 2301. Content in this disclosure refers to anything a user wishes to post from their terminal (whether a mobile or stationary computer terminal) onto one or a plurality of venues or social media platforms. What may be posted may be a user created message or a message that the user wishes to “forward” which was created by a third party.

Next, the system may notify the user if the content of the message is accepted or rejected 120 based on the established parameters including any parameters customized by the user (e.g., 2301). The system may also provide a sentiment associated with the message (e.g., positive, negative, neutral) 604 with the variations being substantial.

If the message is accepted, the message is transmitted to one outlet or a plurality of outlets transmitted simultaneously from the standpoint of the user (outlets such as social media platforms, email, email lists, mobile phone or text message) 122. If the message is rejected, the user may edit the message and send through the system for screening 102-124. One variation is that at this juncture, the user may select override and push the rejected message through to the social media platform(s) 124. Social media platforms refer to any venue whereby communications may be made to one or a plurality of individuals. This may be online, through an application, or on a screen or communication observed by one or many people, such as blasts made on a digital screen at a sporting event for the purpose of dynamic, changing advertising.

The illustrative method embodiment in FIG. 1 shows the message going to a user level fork 116 where decisions are made as to the suitability of the message content 118. This is where according to an embodiment, the user provides their own customized parameters, (e.g., 2301), defining content to be blocked or subject to an alert, although the user may not have to process the message content for the existence of those parameters. For instance, in a corporate setting, the blocked content might be information on a competing business. That information might come through the system as simple text or through other media such as information on images, audio, or video. A political user may want to block messages with content from questionable origin. The system is specially programmed to block content originating from sources that tend to be controversial. This is the banned trifecta known in etiquette as “sex, politics, or religion.” A level of scrutiny or screening may be adjusted by an administrator based on communications that are determined to be allowable.

For example, “retweets” are blocked if the originate from sources that are religious, political, or sexual in nature, or have links to such organizations. The system currently screens sources friends and friends of friends within two degrees of separation, but may be modified by those skilled in the art to provide further degrees. Sources and origins are public sources, such as a social media presence or website. The public presence is screened as content of messages are screened, such as using keywords to identify whether the links, websites, public profile or social media presence of the friends' or friends of friends in the feed are religious, sexual, or political in nature, images screened for nudity, images scanned for offending text. The block would act to notify the political user as to potential problems which merit further review. Or the block serves simply to protect the political user from an unintended affiliation. Of course, this feature does not have to be limited to use by a political campaign or political user. Content with inappropriate language (e.g., cussing, slang, etc.) may be

Although one embodiment includes a screen of inappropriate content, such as content created in error or unwittingly, one skilled in the art may vary the system, for example to capture messages based on positive content. For example in a corporation, the system may be used to measure the output of media by employees and used, for example, as a determinant of productivity. Likewise, the system may be used to pick up on employees' use of positive markers in their communications as a tool used by upper level managers to determine suitability for promotion or changing of an employees' role.

Another example of customized content which may be screened includes, for example, discussions of a competing brand or use of images such as third party logos in a message. These may be screened per company policy to reduce or eliminate discussion of brands other than those of the user organization.

Likewise, those skilled in the art may create a variation whereby third party logos, names of public figures, etc. are rejected when used alone or in conjunction with words with negative connotations. This may protect the user from potential issues of defamation of character.

According to yet another embodiment, one skilled in the art may use the system to tailor content according to targeted populations for the purpose of marketing, such as email lists of parties grouped together for some corporate strategic means. For example, an email list may be established for user's customers who follow a certain product line or have indicated certain preferences. Communications to these parties may be screened so as to include a certain number of references to products tailored to this class of customers or screened to ensure withholding content deemed inappropriate for the class of customers. For example, for a user company specializing in beauty products, a certain class of customers may have indicated preferences for certain types of beauty products, but indicated sensitivities to other products based on skin type. In order to provide better, more targeted communication to these particular customers, for example, products suitable for sensitive skin may be discussed in communication blasts, but information on harsher beauty treatments, such as chemical peels, may be screened out.

Another embodiment is the use of the system to deter hackers who come across social media passwords and then use the user's account to send out unsavory messages, sometimes containing bad links or other inappropriate content. The system may be used to instantly block such messages from being publicly broadcast.

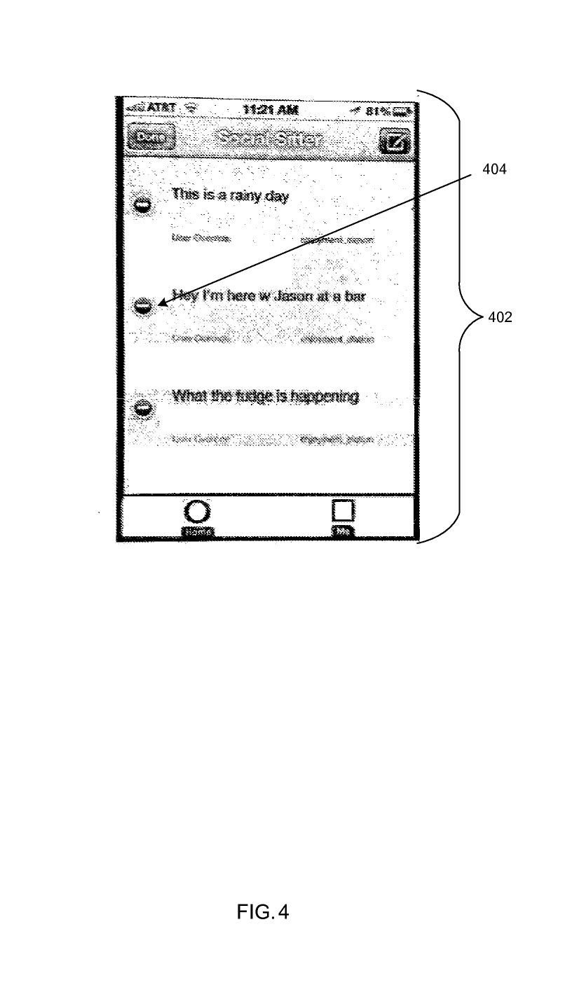

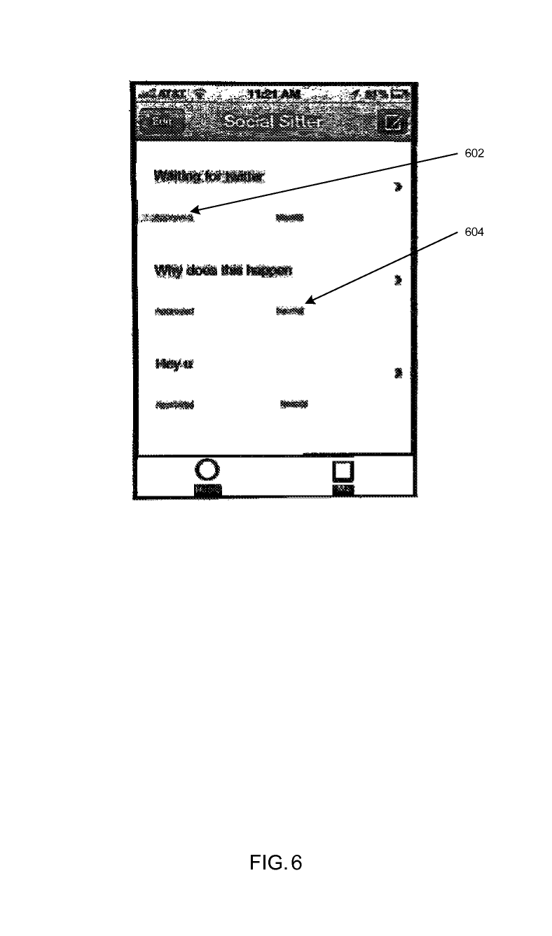

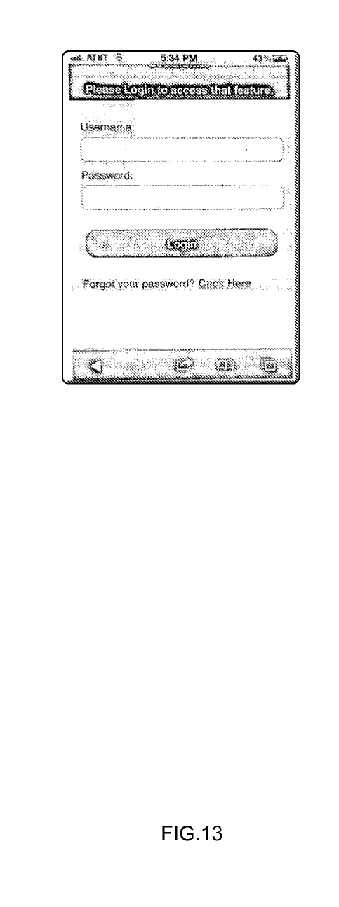

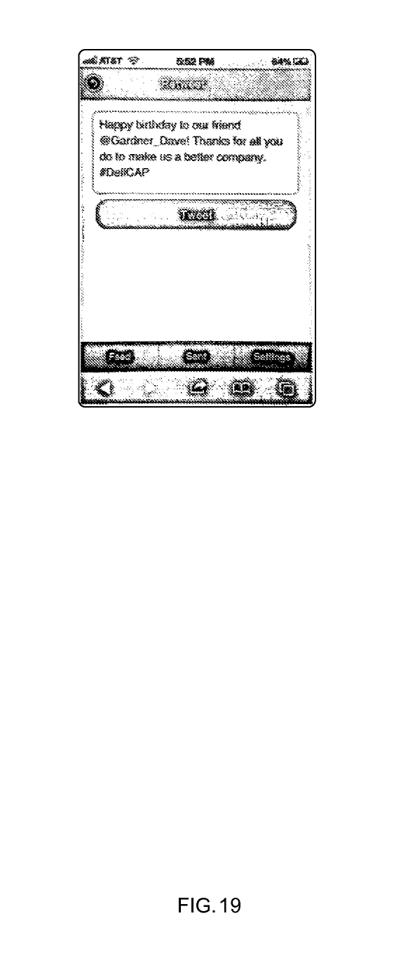

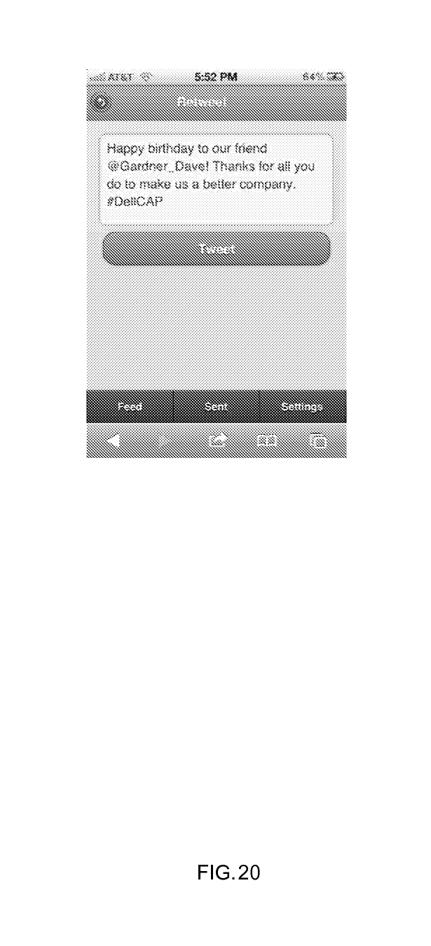

FIGS. 2-10, show embodiments where the social media platform is Twitter. In the below explanation of an illustrative user display where the system is used with Twitter (explanations associated with FIGS. 2-20), it is not intended that these drawings are the sole embodiment or display. FIGS. 2-10 show one type of user interface and FIGS. 13-20 show another example display. The “look and feel” of the display is not critical, although the functionality may be utilized across a number of communications systems, social networks, and so forth. These figures are provided to show enablement and to provide an example display. The screenshots, for the purpose of brevity, show the social media platform, Twitter, being used by the user, however, this is provided as an example only, as the system is configured to post on all major media venues, and may be updated as new venues become popular. Other variations and embodiments described in the Summary and Detailed Description, such as with other social media platforms, for individual or organizational users, using messages which include content other than text, etc. are not excluded.

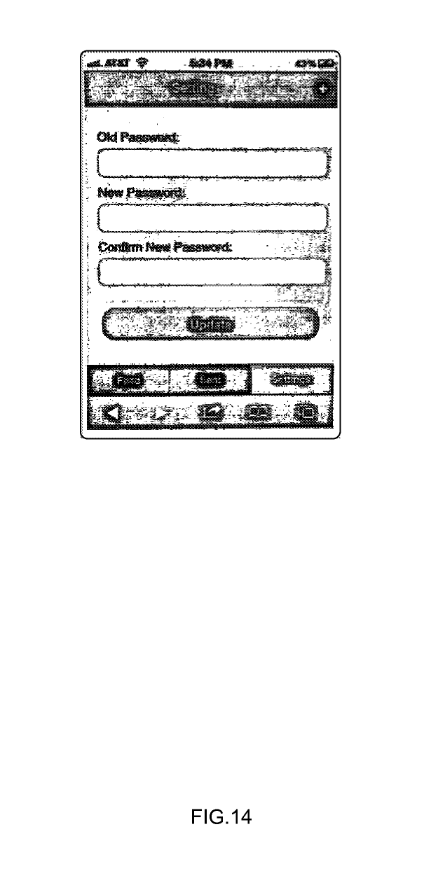

Starting with FIGS. 2, 2A, and 13, these drawings illustrate an example login process where the user may authenticate the service through actions which identify the user, such as email account 202 and password information 204. FIG. 2B illustrates an example display whereby the system is engaged when the user may agree to a terms of service 204b. Login info may be changed in settings. FIG. 14. The login feature is not a required component of the system, but it is an acceptable variation.

From the login process, FIG. 2B illustrates an example display 202b whereby the user's communication platforms are authenticated. In this example, the social media platform, Twitter may be used 204b. Authentication refers to the process whereby social media or other communication accounts are verified as appropriately accessible to the user by means known in the art for verifying identity, such as using previously established account information associated with FACEBOOK™, TWITTER™, and the like.

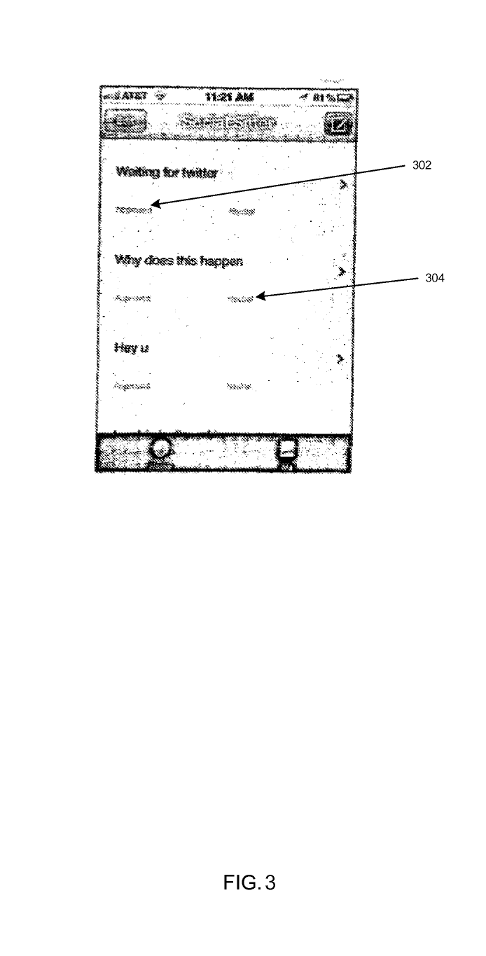

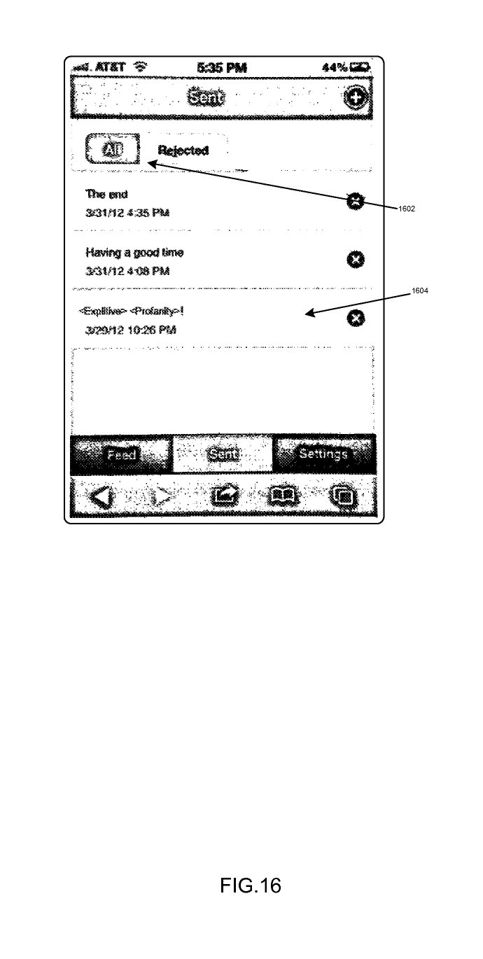

The system may have an interface showing the message history that the user created, as shown in FIGS. 3 and 16. The user may also have the ability to delete message history 404. In the message history, the approval or rejection is present after the system screens the message 302.

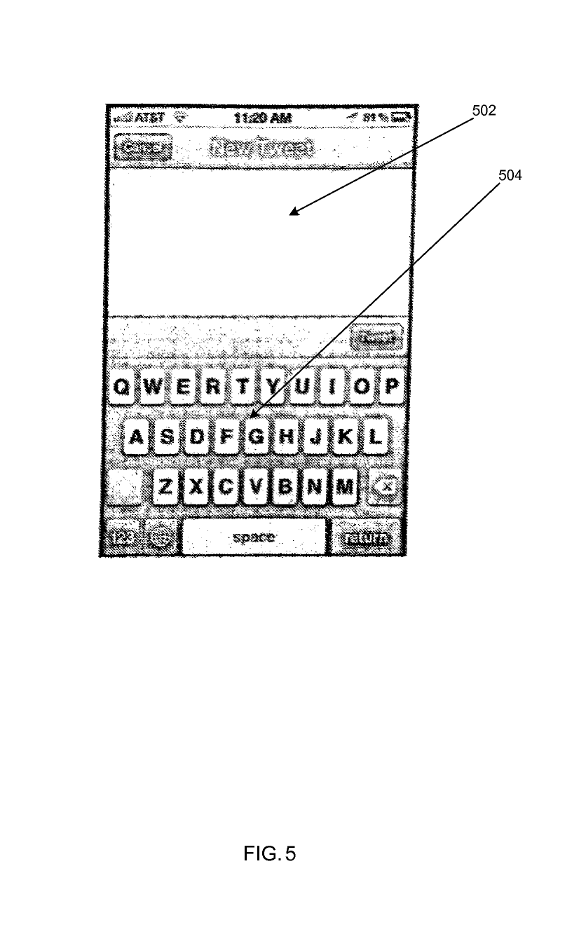

FIGS. 5 and 15 illustrate when a user selects the action to start a new message 502, 1502. If using certain user devices consisting of smartphones, the embodiment may use standard icons to perform similar functions. In this way, to create a new message on, for example, an iPhone, the user may select the icon on the upper right hand side of the service showing a pencil in a square. This location for the start of a message is a marketplace identifier for this action, meaning, it is now industry standard to select the upper right hand button to designate to create a new message.

When the user wishes to create a message in one embodiment, the keyboard is presented and the user may type a message for Twitter; and Facebook, and any other social media platforms designated by the user 118, 504. The number of characters in the message which may be permitted depends on the limits set by the social media platform or combination of one or a plurality of social media platforms where the user intends to broadcast the message. In addition to social media platforms, other venues may interface with the integrated social media system including mobile and text message gateways with various carriers, email provider systems, web entities, or inter-organization communication systems.

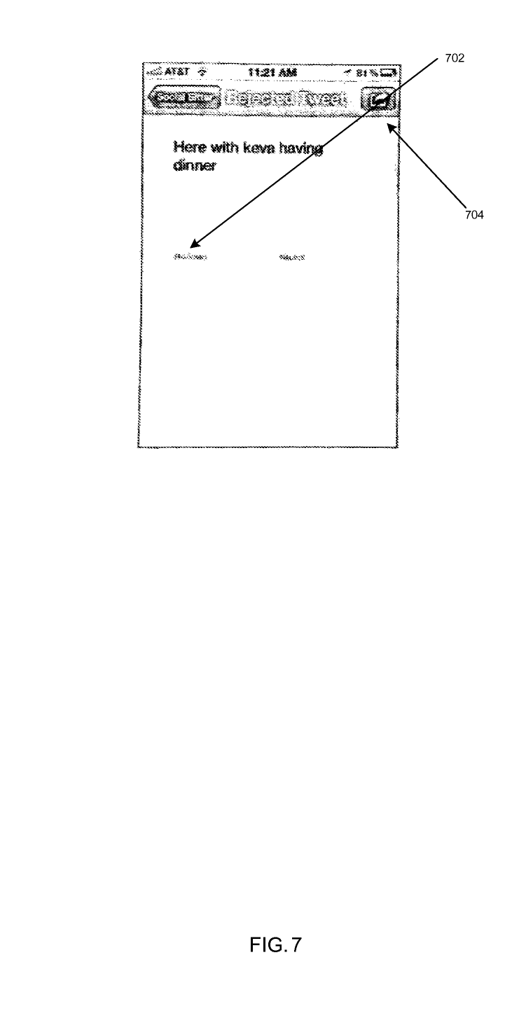

Once a message is sent (meaning completed from the standpoint of the user), if the content screened is not found to consist of prohibited content, the instant replay of approval is displayed in one embodiment 602. A sentiment associated with the message may also be displayed along with the message, for example 604, although the sentiment is a variation and is not required by the one embodiment. When the message is approved, the message is transmitted to the user's authenticated and designated social media platform(s). The message may be posted instantly or at a time scheduled by the user. When a message is found to have prohibited content, an illustrative display of a rejected message may be shown 702, as for example in FIG. 7.

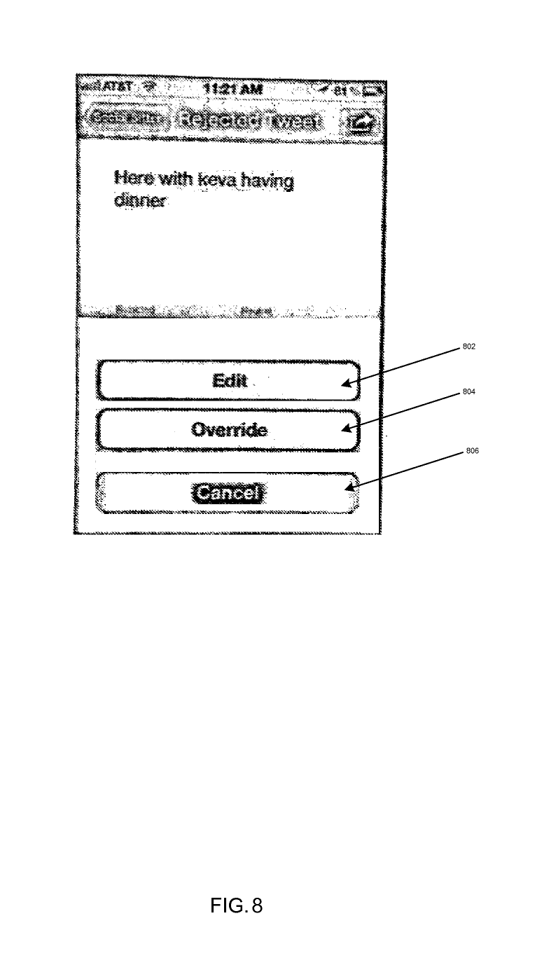

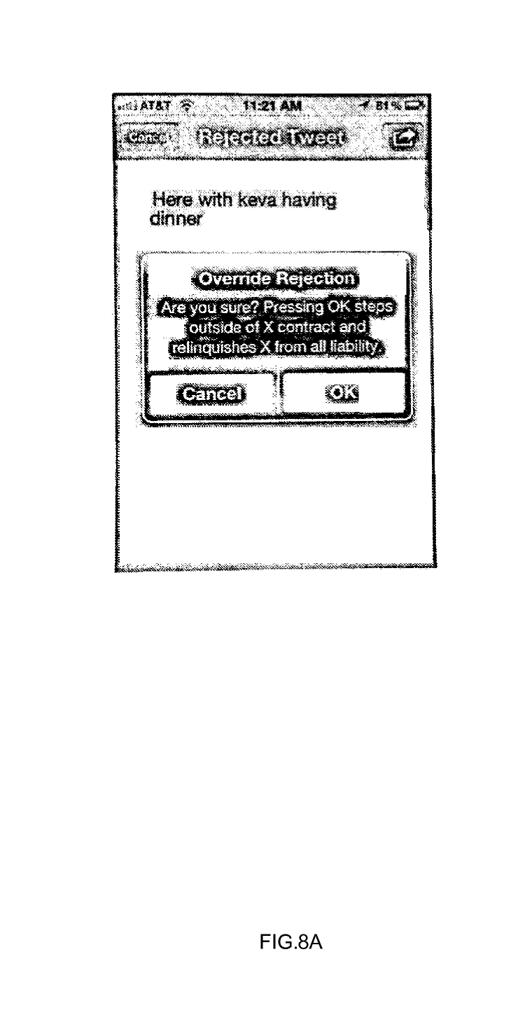

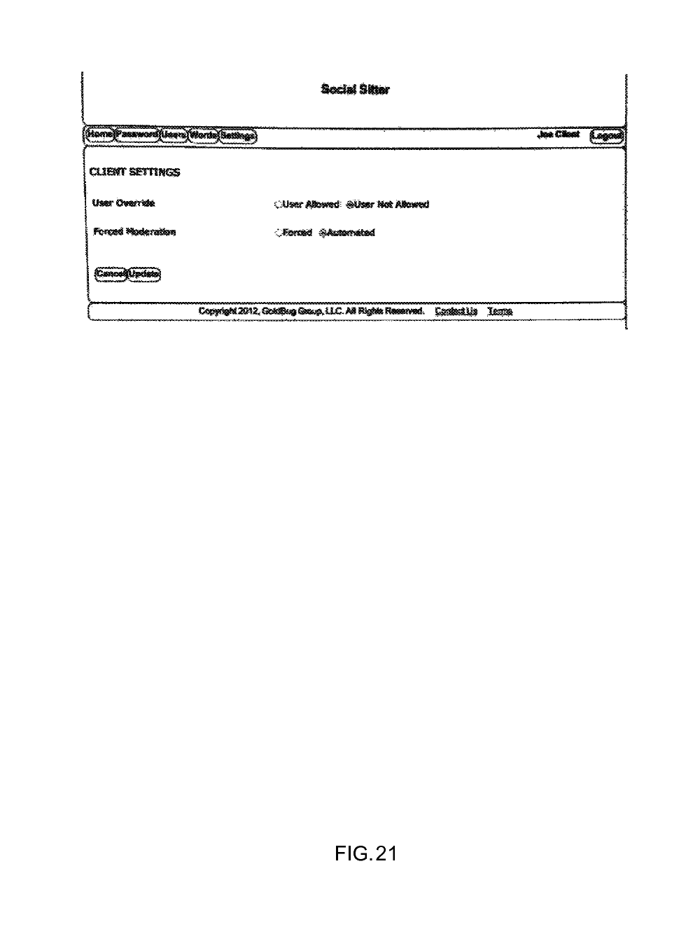

In the event of a rejected or blocked message, the user may also have the option in one embodiment to edit or override by selecting the upper right hand icon 704. When that occurs, FIG. 8 shows an illustrative display for the user giving choices of editing 802, overriding 804 or canceling 806 selections. FIG. 8A is an illustrative display of an override function. When the override button is selected the notification may be, but is not required to be, a warning, in this variation, a notification that the user steps outside a terms of service agreement. If override is selected, the message is pushed through to the user(s)' respected social media platform(s) as if it were an accepted message. As this is an illustrative embodiment, users who purchase the system may be used by a public group, such as an NFL team who need assistance screening content spoken publicly by players which might be best kept out of a public domain, or as a way to turn communications into complying text. It should also be pointed out here that when used, for example as a parental control, the creator of the message does not always have the ability to override a rejection notification, FIG. 21. Administrative users (such as parents over children or employers over employees) may force the user to submit to the moderation (e.g., inability to transmit the message blocked).

As mentioned earlier, the system not only allows for the screening of user created messages, but also messages created by social media “friends” or “followers”. In this way, if the user decides to forward messages not written on the user's device, those messages are also screened in accordance with the various embodiments disclosed. This is a very important feature of the system, especially when used in conjunction with user devices used by children or by aides and candidates in political campaigns. With children, the ability to block content of messages originating from third party sources is key to stop the wildfire transmission of message content across vast web-like networks of children and teens which may harm or taunt a child. As children forward content en masse to all their friends and followers, which may then be passed on to their friends, etc. Any link posted by one child to, for example, a pornographic website, may be blocked so it does not reach that child's network and go viral within a school. As a parental control, this may be used to put a damper on the viral nature of, for instance, a sexting post that a child receives from a third party. If that child has an urge to forward the damaging post, he or she may be blocked from doing so. In this manner, the child associated with the unfortunate image may be spared even more public humiliation. As a parental control, images of faces are always blocked for parental override prior to posting for the express purpose of protecting children from themselves.

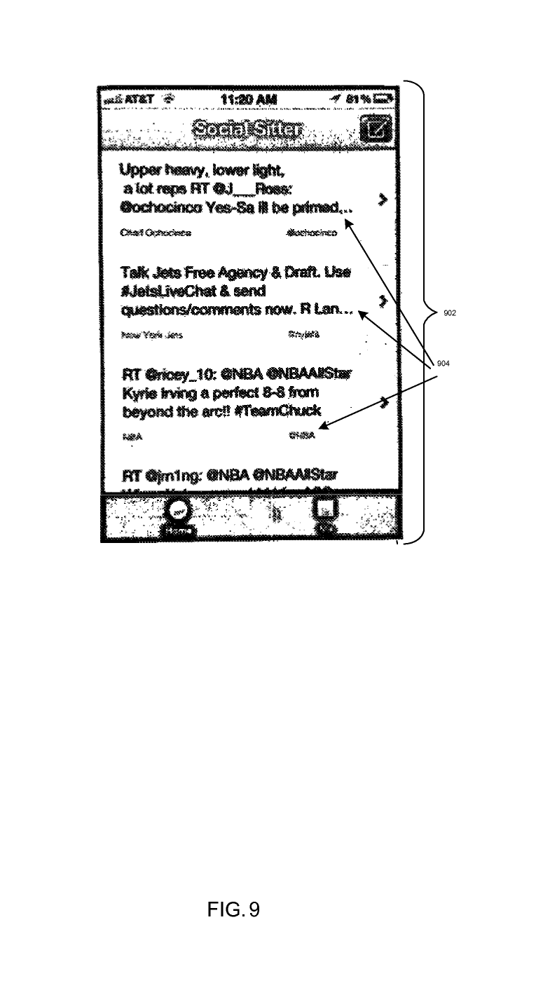

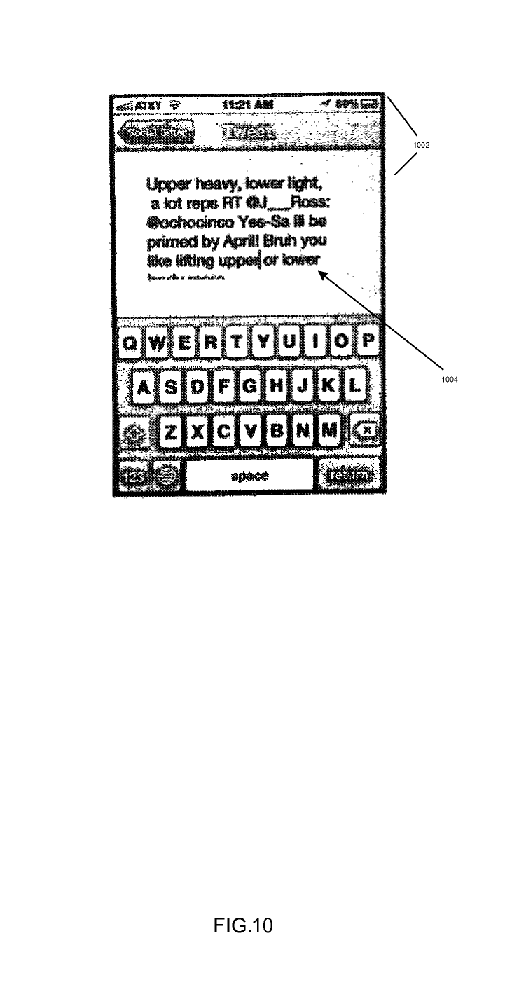

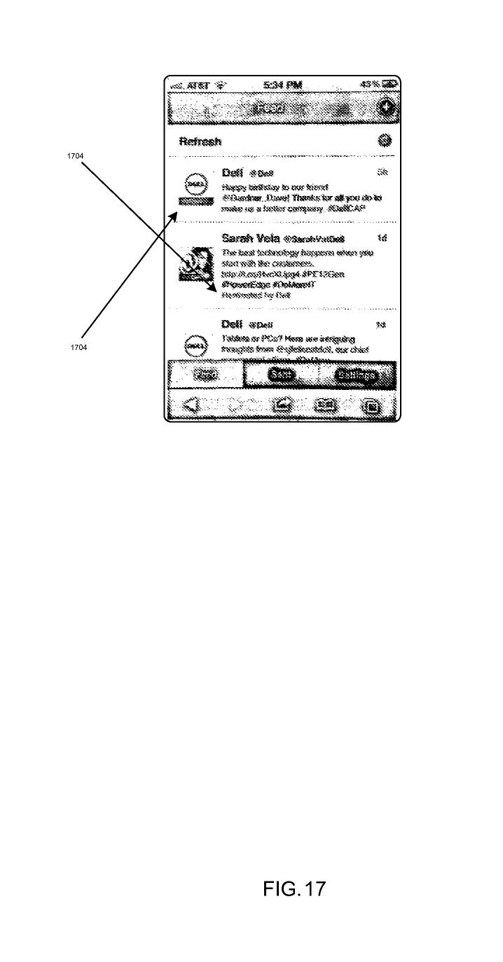

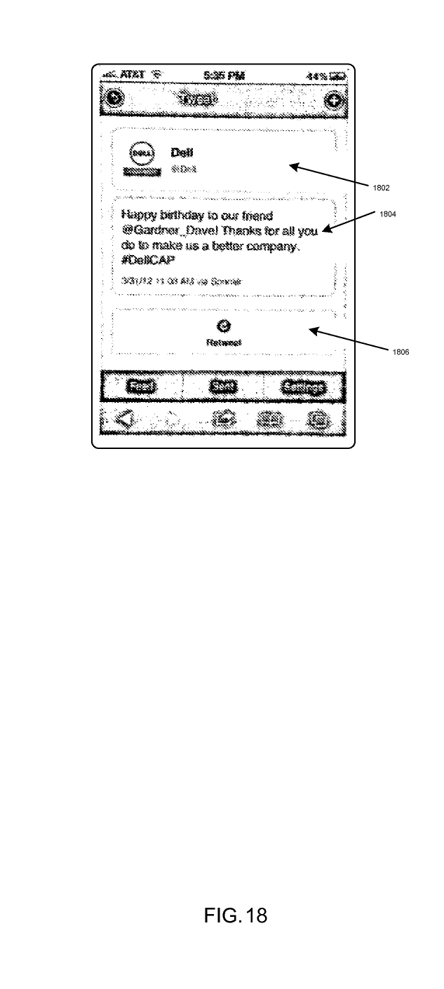

FIGS. 9 and 17 are illustrative displays of the message history of the user's social media “follower or friends” messages with arrows allowing the message to be forwarded and screened through the system. To that end, FIG. 10 shows an example display of a third party message 1004 from FIG. 9 which populates the message interface 1002 allowing it to altered, if the user chooses, then filtered by the system so that it prior to being approved for forwarding or reposting by the user. 1002. FIG. 18 shows the third party message 1804 chosen from the feed shown in FIG. 17 which may be “retweeted” 1806. In the case of forwarded messages, one variation previously discussed is that not only message content, but also origin of the user may be screened. In the case of origin, the public presence of the friend or follower is screened as well.

In the scenario above, the system may screen incoming messages with offending content prior to the message being forwarded. Alternatively, the user in choosing to forward all or a portion of the third party the message may have the screen take place at the time the user forwards all or a portion of the message. As with any user-created message, the computing unit used to enable the system may also be programmed to relay a message at a specific time in the future. Or, the message may be screened and relayed instantaneously.

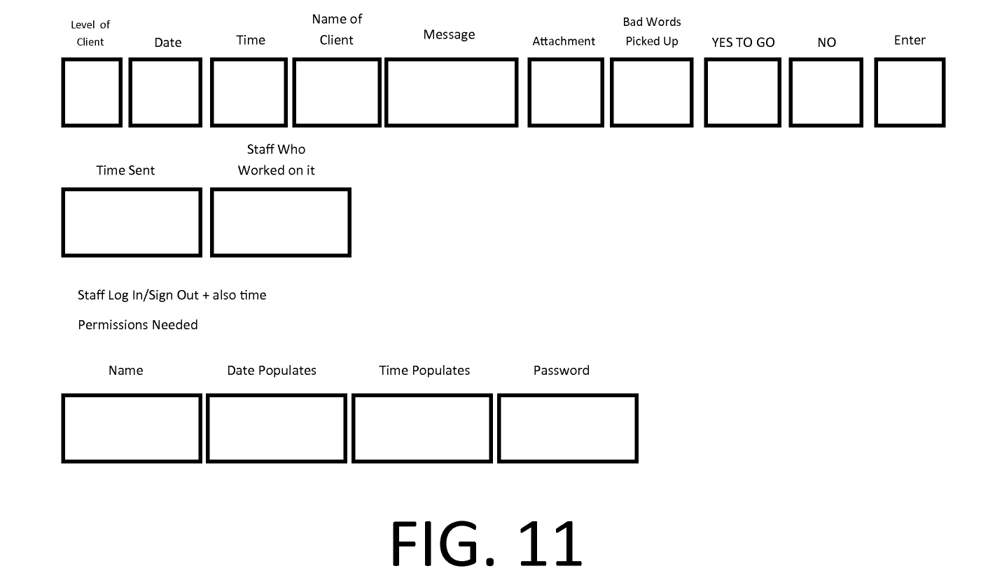

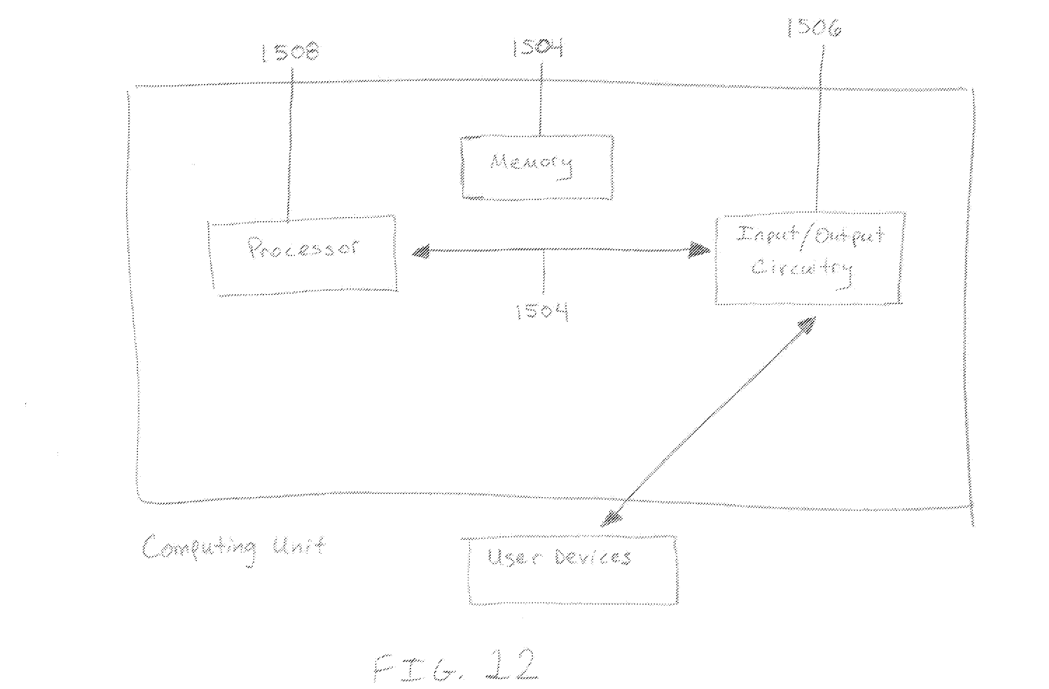

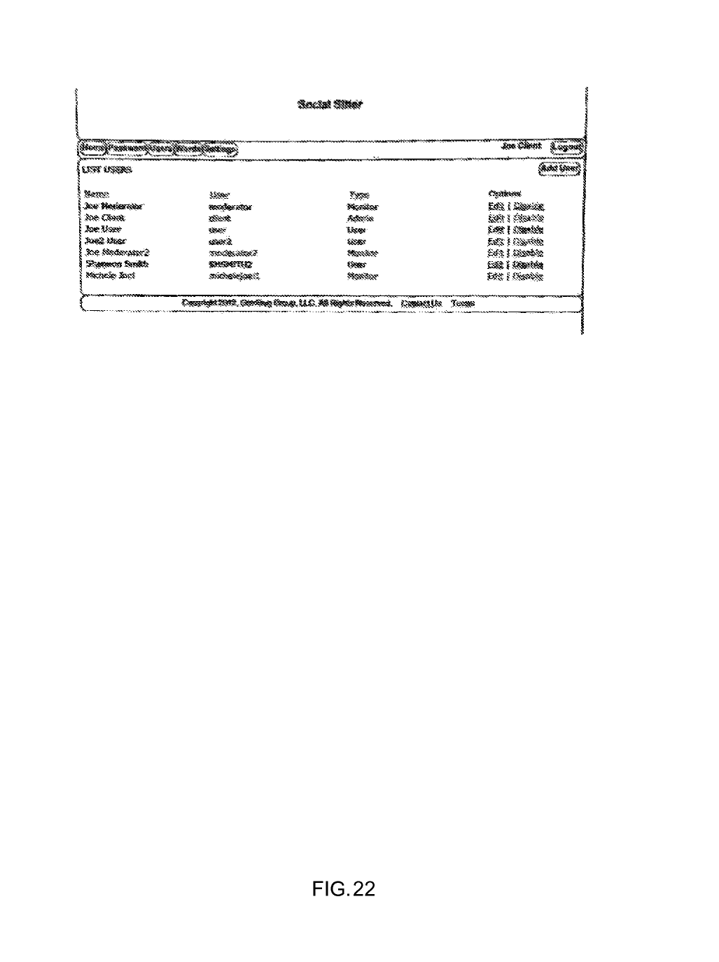

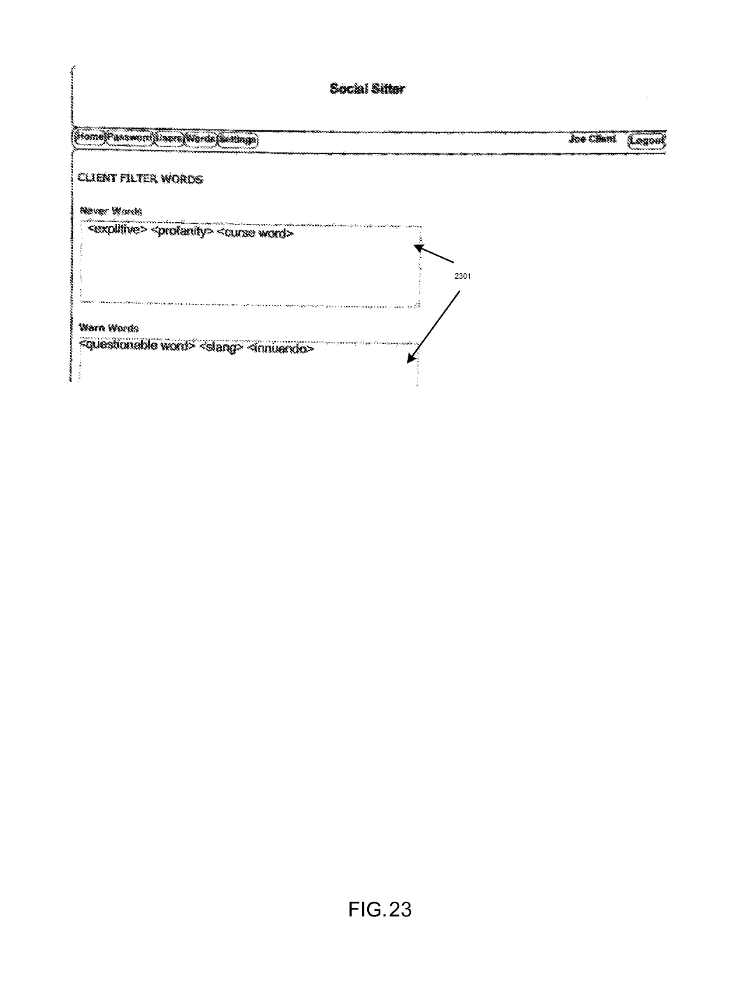

FIGS. 11 and 22 illustrate examples of client administration or the super administration functionalities for an embodiment whereby a corporation uses the filter for the purpose of screening employee(s)' social media blasts. The backend database server may host and store each employee's device and classify whether the message may go to a super administrative user or a corporate client user. As used herein the super administrator may be a corporation not affiliated with the corporation whose employees are being monitored (the corporate client administrator). This super administrator may be a third party monitoring service which may use the system embodied using user devices to provide an appropriate social media communication “face” to its client company for the purposes of, for example, public relations. This illustrative backend allows the super administrator permissions to monitor each individual user within the client company whose social media posts are filtered by the system.

The example administrative console in FIG. 11 is comprised of a super administration and client administration, where the final approval and reject notification is screened. The super administrator or client administrator has the ability to see all primary users' message histories and see whether any were rejected and the basis therefore. Any message auto- blocked may be edited at this secondary level. A client administration is created in the case that a corporate user wants to monitor their own employee primary users and they have the same ability, in a secure login and password, to oversee the accept and reject feature earlier described. The corporate embodiment does not require a super administrator if the client wishes to operate the system directly.

The administrative console (both super and client) screens content such as each word, phrase, website URL (and the content on that page), picture, slang word, abbreviation, context, audio, and video. Additionally, the client console administration provides a report for the organization.

Finally, as with all embodiments discussed herein, not only may social media platform usage occur, but it may also be used for any electronic communication service.

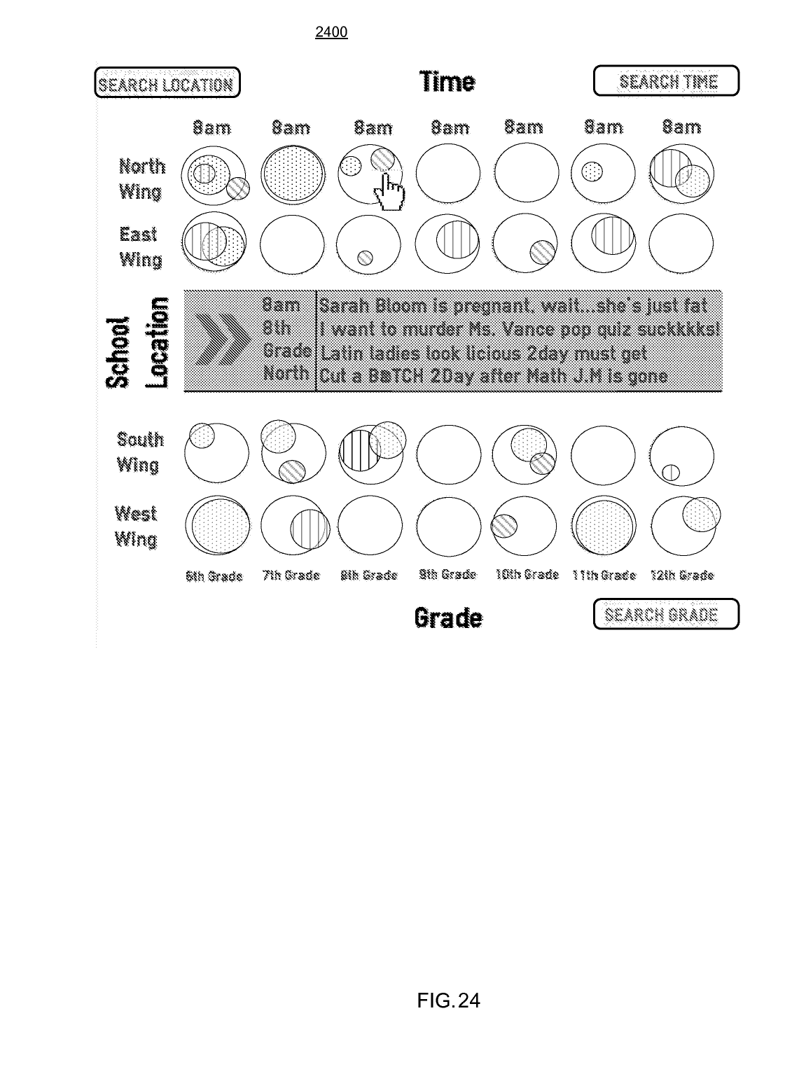

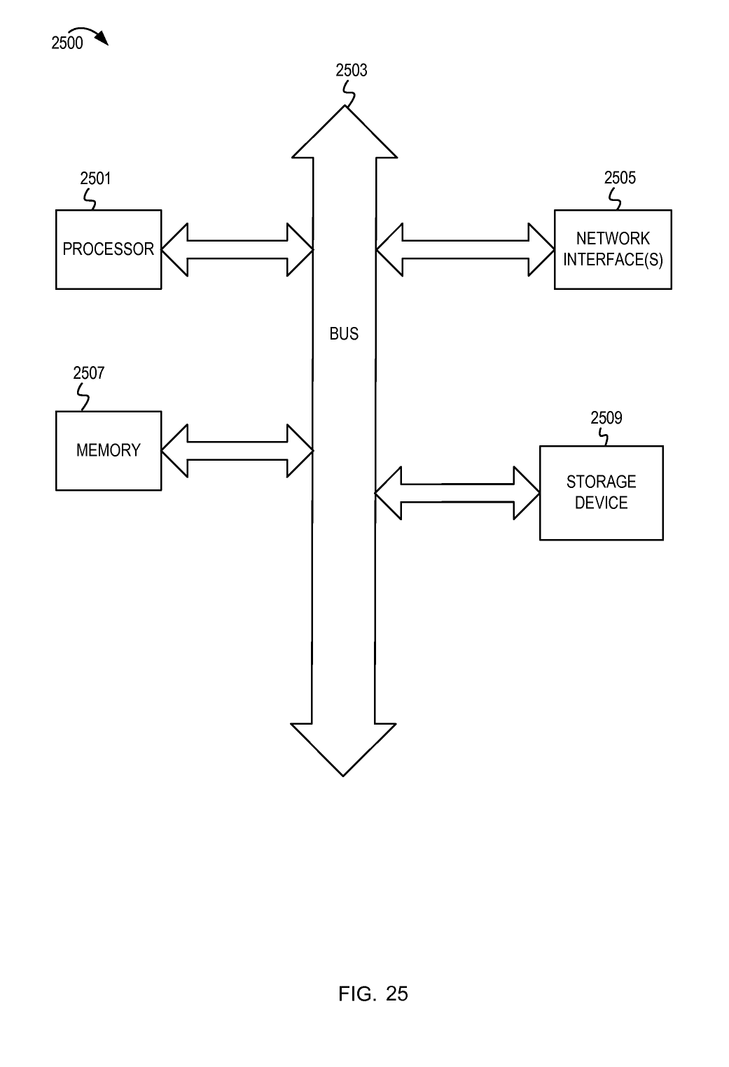

FIG. 24 shows an example display for a heat map 2400 in accordance with an illustrative embodiment. The heat map may be configured to graphically show search locations and times. The heat map 2400 may be a graphical representation of individual assessments that are aggregated for display. The information and data associated with the heat map 2400 may be presented in any number of user friendly or intuitive systems.

In one embodiment, the heat map 2400 may represent a matrix based on a time period (e.g., class period, day, week, year, session, etc.) for an individual user or groups of individuals (e.g., students, employees, self-selecting group, etc.). Any number of other indices may also be included in the heat map 2400. In one embodiment, the content may be assigned various degrees of threat or otherwise rated based on importance. The heat map 2400 may be representative of occurrences that supervisors, administrators, or other responsible parties may not be otherwise aware of The heat map 2400 may identify importance trends or practices utilizing a threat assessment approach to allow persons in authority to proactively deal with potentially negative situations, such as bullying, fights, dangerous activities, and so forth. The heat map 2400 may be available through an administrator dashboard provided by the system.

A user may utilize the heat map 2400 to search through available information or content based on classifications of users (e.g., class, age, department, assignment, etc.), time of day, severity of threats or rating, and so forth. In one embodiment, the heat map 2400 may be color coded to more visually present information to the user. For example, red information may indicate high events or threats, orange may indicate middle level events or threats, yellow may indicate neutral events or threats, and green my indicate positive events (e.g., non-threats).

In one embodiment, the heat map 2400 may include a graphical representation of location and a location from which the communication(s) originated, were posted, read, or so forth. For example, communications may be denoted on a map. The map may be expansive or may be limited to a region, facility, or other specified location. The individual events or threats may be selected and reviewed from the heat map 2400 to review content in real-time.

The system may include agreements, waivers, or an understanding that the individuals being tracked are being recorded based on contractual agreement, applicable law, or so forth to prevent unwanted or unauthorized violation of user's privacy.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

FIG. 25 depicts an example computer system 2500. A computer system 2500 includes a processor 2501 (possibly including multiple processors, multiple cores, multiple nodes, and/or implementing multi-threading, etc.). The computer system includes memory 2507. The memory 2507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 2503 (e.g., PCI, ISA, PCI-Express, HyperTransport®, InfiniBand®, NuBus, etc.), a network interface 2505 (e.g., an ATM interface, an Ethernet interface, a Frame Relay interface, SONET interface, wireless interface, etc.), and a storage device(s) 2509 (e.g., optical storage, magnetic storage, etc.). The system memory 2507 embodies functionality to implement embodiments described above. The system memory 2507 may include one or more functionalities that facilitate filtering, screening, and managing content sent to or from the computer system 2500. Any one of these functionalities may be partially (or entirely) implemented in hardware and/or on the processing 2501. For example, the functionality may be implemented with an application specific integrated circuit, in logic implemented in the processing 2501, in a co-processor on a peripheral device or card, etc. Further, realizations may include fewer or additional components not illustrated in FIG. 25 (e.g., video cards, audio cards, additional network interfaces, peripheral devices, etc.). The processor 2501, the storage device(s) 2509, and the network interface 2505 are coupled to the bus 2503. Although illustrated as being coupled to the bus 2503, the memory 2507 may be coupled to the processor 2501.

While the embodiments are described with reference to various implementations and exploitations, it will be understood that these embodiments are illustrative and that the scope of the inventive subject matter is not limited to them. In general, techniques for filtering, screening, and managing content as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for filtering improper content comprising:
receiving a communication for transmission from a first device;
reviewing the communication to determine whether the communication includes the improper content; and
filtering the communication in response to determining the communication includes the improper content.

2. The method of claim 1, wherein the communication is a communication in a social media site.

3. The method of claim 1, wherein the improper content includes explicity language, political content, sexual content

4. The method of claim 1, further comprising:
providing information regarding communications that are filtered due to improper content.

5. The method of claim 1, further comprising:
determining a location associated with the first device when attempting to transmit the communication.

6. The method of claim 1, wherein the receiving, reviewing, and filtering is performed for a plurality of communications across a plurality of communications platforms.

7. The method of claim 1, further comprising:
rating communications from the first device.

8. The method of claim 1, further comprising:
alerting a user of the first device that the communication includes the improper content.

9. The method of claim 1, further comprising:
receiving input to overcome the filtering in response to the user overriding an alert communicated through the first device.

10. The method of claim 1, wherein the communication is a forwarded message.

11. One or more machine-readable media having stored therein a program product, which when executed a set of one or more processor units causes the set of one or more processor units to perform operations that comprise:
receive a communication for transmission from a first device;
review the communication to determine whether the communication includes the improper content; and
filter the communication in response to determining the communication includes the improper content.
